(19) United States
(12) Patent Application Publication
(10) Pub. No.: US 2006/0031863 A1
(43) Pub. Date: Feb. 9, 2006

(54) Disk chucking apparatus for small-sized disk player

(75) Inventors: Young-yun Seol, Seoul (KR); Jung-jae Lee, Yongin-si (KR); Hwan-seung Lee, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/195,804

(22) Filed: Aug. 3, 2005

(30) Foreign Application Priority Data
Aug. 6, 2004 (KR) 2004-62013

(51) Int. Cl. G11B 7/08

(52) U.S. Cl. 720/658

(57) ABSTRACT

A disk chucking apparatus for a disk player, having: a turntable on which a disk is seated; a clamper unit to clamp the disk to the turntable; and a holder unit, disposed on a main chassis to be approachable to and separable from the turntable, and pressing the clamper unit when the disk is clamped to the turntable, the clamper unit being rotatable.

### CROSS-REFERENCE TO RELATED APPLICATIONS

This application claims the benefit under 35 U.S.C. §119(a) of Korean Patent Application No. 2004-62013, filed on Aug. 6, 2004, in the Korean Intellectual Property Office, the entire contents of which are incorporated herein by reference.

### BACKGROUND OF THE INVENTION

1. Field of the Invention

The present invention relates to a disk player, and more particularly, to a disk chucking apparatus for a small-sized disk player.

2. Description of the Related Art

A disk player records data on a disk such as a compact disk (CD), a CD-ROM, a digital video disk (DVD), or a DVD-ROM and/or reproduces data from the disk. And the disk player has a disk loading apparatus to load the disk to a position for recording or reproducing the data. A disk is inserted into the disk player and conveyed to a chucking position by a disk conveyance apparatus. After arriving at the chucking position, the disk is rotatably clamped on a turntable by a disk chucking apparatus.

FIGS. 1A and 1B are side section views showing a conventional disk chucking apparatus before chucking and after chucking, respectively. Referring to FIGS. 1A and 1B, the conventional disk chucking apparatus has a clamper 52, a magnet 92, a yoke 93, a holder 10, and a turntable 90.

The clamper 52 consists of an upper clamper 54 and a lower clamper 58. The upper clamper 54 and the lower clamper 58 are assembled with each other such that a hook 56 formed on the lower clamper 58 is hooked into a hook recess 57 formed in the upper clamper 54. The magnet 92 is interposed between the upper clamper 54 and the lower clamper 58. The yoke 93 is disposed on the top of the magnet 92 to reinforce a magnetic force between the magnet 92 and the turntable 90. The holder 10 is located between the upper clamper 54 and the lower clamper 58 to support the clamper 52, and moves up and down in relation to the movement of a slider (not shown) disposed on a main chassis (not shown). The turntable 90 is rotated by a spindle motor 94 to rotate a disk D seated thereon. The turntable 90 has a magnetic substance 70 disposed thereon to generate an attraction with respect to the magnet 92.

Operation of the disk chucking apparatus having the above construction will now be described. The holder 10 descends in relation to the movement of the slider (not shown). The clamper 52 moves down a predetermined distance together with the holder 10. The clamper 52 further descends due to a magnetic attraction between the magnet 92 and the magnetic substance 70. The disk D conveyed and positioned between the clamper 52 and the turntable 90 is clamped to the turntable 90 by the clamper 52. Then, the holder 10 further descends and is located between the upper clamper 54 and the lower clamper 58 without contacting either the upper clamper 54 or the lower clamper 58, so that a space is formed to allow the clamper 52 to be rotated. Through the above-described process, operation of chucking the disk D is completed as shown in FIG. 1B. After that, the clamped disk D rotates together with the turntable 90 and the clamper 52.

At this time, the disk D may be eccentrically rotated due to an eccentricity of the disk D, which causes a wobble of the disk D. To prevent the wobble, the disk D has to be clamped with a predetermined clamping force. The predetermined clamping force is maintained by the attraction between the magnet 92 and the magnetic substance 70. The magnet 92 is required to have a magnetic force sufficient to maintain the clamping force constantly.

To release the disk D from the chucking state, a driving motor (not shown) is rotated in a reverse direction to the direction of the loading process, and moves the slider (not shown) on the main chassis (not shown) in an unloading direction. Then, the holder 10 ascends in relation to the movement of the slider (not shown). The clamper 52 is distanced from the disk D as the holder 10 ascends. At this time, the holder 10 has to overcome the magnetic force to move the clamper 52 upwardly.

In chucking the disk D or releasing the disk D from the chucking state, the magnet 92 is required to have a high magnetic force sufficient to prevent the wobble, which is caused by the rotation of the disk D. But the magnet 92 having the high magnetic force is expensive, and when the disk D is released from the chucking state, the high magnetic force generates a load that hinders the ascending movement of the holder 10 to distance the clamper 52 from the disk D.

Also, since the magnet 92 is interposed between the upper clamper 54 and the lower clamper 58, it increases the height of the clamper 52, which causes an increase of a size of the disk player.

But since a compact-sized or a slim-type disk player is preferred recently, there is a demand for a compact-sized disk player.

### SUMMARY OF THE INVENTION

The present invention has been developed to solve the above problems in the related art. Accordingly, an aspect of the present invention is to provide a disk chucking apparatus for a disk player having an improved construction capable of reducing a load in releasing a disk from a chucking state.

Another aspect of the present invention is to provide a disk chucking apparatus of an improved construction for a compact-sized disk player and a slim-type disk player.

The above and other aspects of the present invention are achieved by providing a disk chucking apparatus for a disk player, having: a turntable on which a disk is seated; a clamper unit to clamp the disk to the turntable; and a holder unit, disposed on a main chassis to be approachable to and separable from the turntable, and pressing the clamper unit when the disk is clamped to the turntable, the clamper unit being rotatable.

According to one aspect, the holder unit has a holder plate disposed on the main chassis, and a press member disposed on the holder plate to press a contact part upwardly protruding from a center of the clamper unit when the disk is clamped to the turntable.

According to one aspect, the press member is a plate spring. According to one aspect, the contact part is dome-shaped.

The above and other aspects are also achieved by providing a disk chucking apparatus for a disk player, having: a turntable on which a disk seated, the turntable having a magnet disposed thereon; a holder unit disposed on a main chassis to be approachable to and separable from the turntable; a clamper disposed at the holder unit, to clamp the disk seated on the turntable; and a magnetic substance disposed on the clamper to generate an attraction with respect to the magnet so that the clamper clamps the disk to the turntable by the attraction, the clamper rotatably contacting the holder unit when the disk is clamped.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIGS. 1A and 1B are cross-section views showing a conventional disk chucking apparatus before chucking and after chucking, respectively;

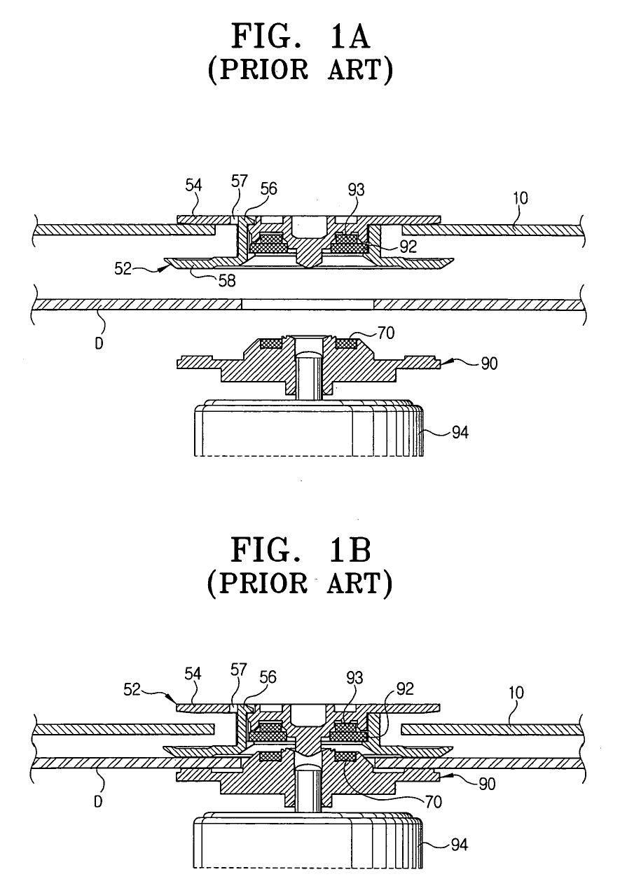

FIG. 2 is a top view showing a disk loading apparatus according to an embodiment of the present invention;

FIG. 3 is an exploded perspective view showing the disk chucking apparatus of FIG. 2; and

FIGS. 4 and 5 are cross-section views taken along lines IV-IV of FIG. 3 to explain the operation of chucking a disk according to an embodiment of the present invention.

### DETAILED DESCRIPTION

Reference will now be made in detail to embodiments of the present invention, examples of which are illustrated in the accompanying drawings, wherein like reference numerals refer to the like elements throughout. The embodiments are described to explain the present invention by referring to the figures.

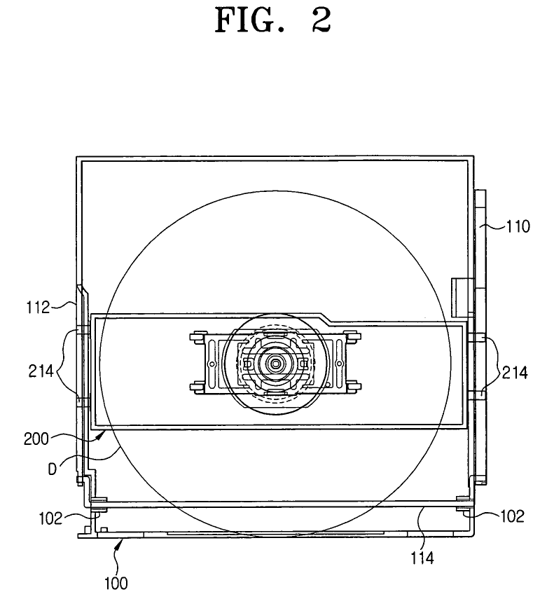

Referring to FIG. 2, the disk loading apparatus according to an embodiment of the present invention has a main chassis 100, a first slider 110 and a second slider 112, a connection member 114, and a chucking apparatus 200.

The first and the second sliders 110 and 112 are disposed on opposite sides of the main chassis 100, and move forwardly and backwardly. The connection member 114 connects the first and the second sliders 110 and 112, and is rotatably supported by a hinge portion 102 provided on the main chassis 100. When the first slider 110 receives a driving force from a driving motor (not shown) and reciprocates on the main chassis 100, the connection member 114 moves the second slider 112 in relation to the movement of the first slider 110, in the same direction the movement of the first slider 110.

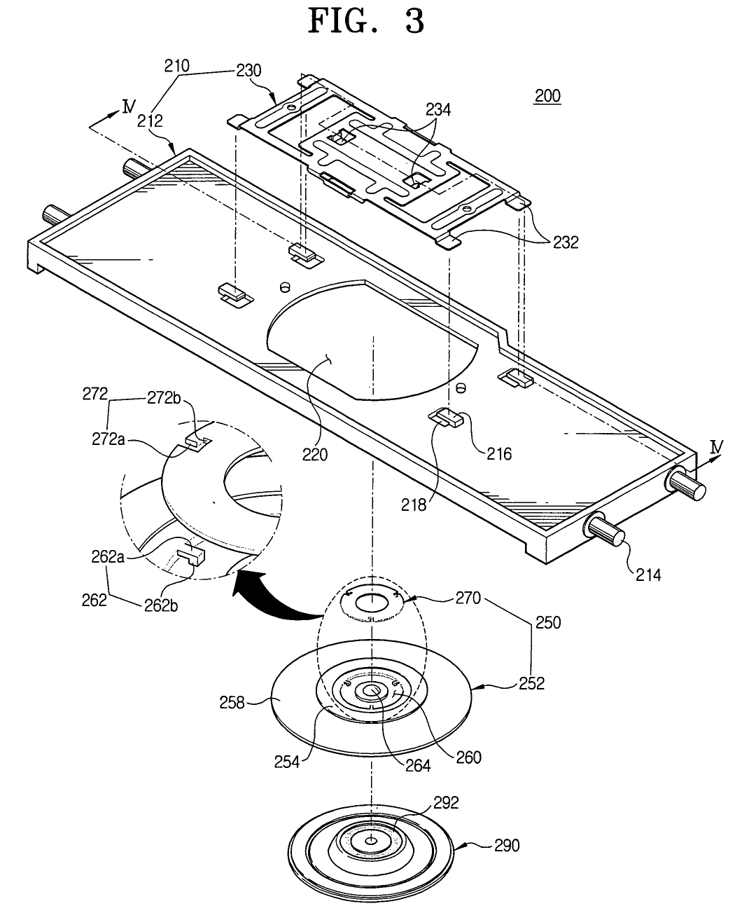

The chucking apparatus 200 is disposed on the main chassis 100. The chucking apparatus 200 has cam pins 214 inserted into cam recesses (not shown) formed in the first and the second sliders 110 and 112. The cam pins 214, which are inserted into the cam recesses, move in relation to a loading or unloading movement of the first and the second sliders 110 and 112, so that a holder unit 210 (see FIG. 3) and a clamper unit 250 (see FIG. 3) of the chucking apparatus 200 ascend or descend on an upper portion of the main chassis 100.

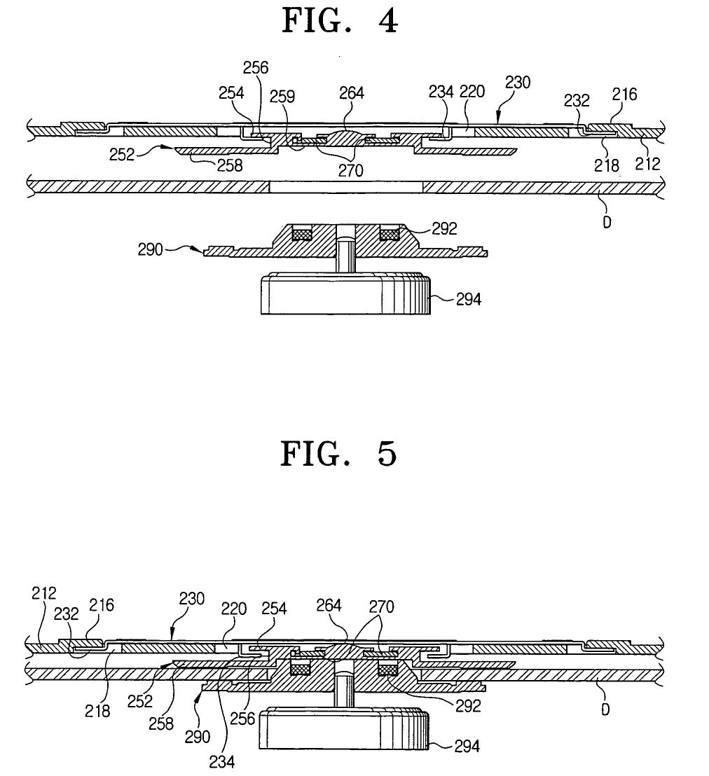

FIG. 3 is an exploded perspective view showing the disk chucking apparatus and FIG. 4 is a cross section view taken along line IV-IV of FIG. 3. Referring to FIGS. 3 and 4, the disk chucking apparatus has a turntable 290, the holder unit 210, and the clamper unit 250.

The turntable 290 rotates together with a disk D loaded thereon, and is driven by a spindle motor 294 mounted on the main chassis 100 (see FIG. 2).

An annular magnet 292 is press-fitted or caulked onto the turntable 290.

The holder unit 210 is disposed on the main chassis 100 and is ascendable and descendible. The holder unit 210 supports the clamper unit 250 so that the clamper unit 250 is attachable to and separable from the turntable 290. The holder unit 210 includes a holder plate 212 and a plate spring 230 acting as a pressing member.

The holder plate 212 is provided with cam pins 214, plate spring connection holes 218, plate spring support projections 216, and a middle hole 220. Two pairs of the cam pins 214 are provided at opposite sides of the holder plate 212. The cam pins 214 are inserted into the cam recesses (not shown) so that the holder plate 212 ascends and descends in relation to the movements of the first and the second sliders 110 and 112 (see FIG. 2). Two pairs of the connection holes 218 are defined in the holder plate 212 symmetrically with respect to the middle portion of the holder plate 212. The plate spring support projections 216 are positioned over the connection holes 218. The plate spring support projections 216 may be integrally formed with the holder plate 212 or attached to the holder plate 212 by welding. The middle hole 220 is defined in the middle portion of the holder plate 212. The plate spring 230 is connected with the clamper unit 250 through the middle hole 220. According to one embodiment, the holder plate 212 and the plate spring 230 are integrally formed.

When a clamper 252 of the clamping unit 250 clamps the disk D, the plate spring 230 presses the clamper unit 250, thereby preventing a wobble from being caused by an eccentric rotation of the disk D. The plate spring 230 is provided with connection pieces 232 and support pieces 234. Two pairs of the connection pieces 232 are formed at opposite ends of the plate spring 230. The connection pieces 232 downwardly bend from the plate spring 230 and are inserted into the connection holes 216 provided in the holder plate 212. According to one embodiment, two support pieces 234 are separated from each other by a predetermined distance, and are oppositely disposed with respect to the middle portion of the plate spring 230. Each support piece 234 downwardly bends from the plate spring 230 to support the clamper unit 250. The plate spring 230 presses the clamper 252 and may use a coil spring for pressing the clamper 252.

When clamping the disk D, the clamper unit 250 has a bottom thereof press-contact the disk D and rotates together with the disk D. The clamper unit 250 includes the clamper 252 and a magnetic substance 270.

The clamper 252 includes an upper flange part 254, a lower flange part 258, a connection part 256, a plate spring contact part 264, and a magnetic substance mounting part 260. The upper flange part 254 is formed on an upper portion of the clamper 252 and has an annular shape. The upper flange part 254 is supported on the support piece 234 of the plate spring 230. The lower flange part 258 is formed on a lower portion of the clamper 252 and has an annular shape. The lower flange part 258 has a larger diameter than the upper flange part 254. A lower surface of the lower flange part 258 contacts the disk D when clamping the disk D, and has a hole 259 defined in a center thereof corresponding to the turntable 290, to allow the turntable 290 to be inserted therethrough. The connection part 256 connects the upper flange part 254 and the lower flange part 258.

The contact part 264 is shaped in a hemisphere that protrudes from the center of the clamper 252. According to one embodiment, since the contact part 264 has a hemisphere shape, it is brought into point-contact with the plate spring 230. The point-contact allows the plate spring 230, which is fixed to the holder plate 212 to press the rotating clamper 252. The contact part 264 may be dome-shaped, or may take various configurations if it is made of a material having low friction.

The magnetic substance mounting part 260 is depressed in an annular shape with respect to the contact part 264. Due to this shape, the magnetic substance 270 can be mounted on the magnetic substance mounting part 260 without increasing the height of the clamper 252. The magnetic substance mounting part 260 has a connection protrusion 262 to be engaged with the magnetic substance 270. According to one embodiment, the connection protrusion 262 is formed in a “ [symbol] ” shape, and there are three connection protrusions 262 formed at a predetermined interval along a radial direction. The number of connection protrusions 262 increases or decreases depending on the size or thickness of the magnetic substance 270. The connection protrusion 262 has an insert protrusion 262a and a locking protrusion 262b. The insert protrusion 262a protrudes toward a center of the magnetic substance mounting part 260, and the locking protrusion 262b downwardly protrudes from an end of the insert protrusion 262a.

The magnetic substance 270 generates a magnetic attraction with respect to the magnet 292 disposed on the turntable 290, thereby allowing the clamper 252 to press the disk D. The magnetic substance 270 has an annular shape so that it is mounted on the magnetic body mounting part 260. The magnetic substance 270 has three connection recesses 272 formed therein to be connected with the connection protrusions 262. Each connection recess 272 is divided into an insert part 272a and a locking part 272b.

The insert part 272a is formed toward a center portion of the magnetic substance 270. The insert protrusion 262a of the connection protrusion 262 is inserted into the insert part 272a when the magnetic substance 270 is mounted on the magnetic substance mounting part 260 downwardly. The locking part 272b is formed from an end of the insert part 272a in a radial direction of the magnetic substance 270. The locking protrusion 262b of the connection protrusion 262 is locked into the locking part 272b when the magnetic substance 270 rotates after the insert protrusion is inserted into the insert part 272a. Accordingly, by simply rotating the magnetic substance 270, the magnetic substance 270 is securely mounted on the magnetic substance mounting part 260.

Hereinafter, operation of the disk chucking apparatus according to an embodiment of the present invention will now be described.

FIG. 4 is a cross-section view showing the clamper and the disk before chucking, and FIG. 5 is a cross-section view showing the clamper and the disk after chucking. Referring to FIGS. 4 and 5, the first and the second sliders 110 and 112 (see FIG. 2) slide on the main chassis 100 (see FIG. 2). In relation to the sliding movements of the first and the second sliders 110 and 112, the holder plate 212 descends. At the same time, the plate spring 230 disposed on the holder pate 212 and the clamper 252 having the upper flange part 254 supported on the support pieces 234 descend. As the holder plate 212 and the plate spring 230 descend by a predetermined distance, the clamper 252 is brought into contact with the disk D so that the disk D is seated on the turntable 290. After that, the holder plate 212 and the plate spring 230 further descend and the plate spring 230 presses the contact part 264. At this time, as the plate spring 230 descends, the support pieces 234 of the plate spring 230 are positioned between the upper flange part 254 and the lower flange part 258 of the clamper 252. That is, the support pieces 234 do not contact the clamper 252, so that the clamper 252 can be rotated.

When the chucking operation is completed as described above, the clamper 252 presses the disk D onto the turntable 290 due to a magnetic attraction exerted between the magnetic substance 270 and the magnet 292 and a pressure of the plate spring 230 exerted to the contact part 264. After that, when the turntable 290 is rotated by the spindle motor 294, the disk D and the clamper 252 are rotated. Also, since the contact part 264 of the clamper 252 point-contacts the plate spring 230, the clamper 252 can be rotated in a state that the plate spring 230 is fixed to the holder plate 212. As described above, the clamper 252 is rotated while pressing the disk D, thereby preventing a wobble from being caused by an eccentric rotation of the disk D.

As noted previously, the conventional disk chucking apparatus has to use a magnet having a high magnetic force to prevent the wobble of the disk D. In contrast, according to an embodiment of the present invention, since the clamper 252 presses the disk D with the pressure of the plate spring 230 and the magnetic attraction, the magnet is not required to have a high magnetic force.

To release from the chucking state, the driving motor (not shown) is rotated in a reverse direction to that of the above loading process. When the first and the second sliders 210 and 212 (see FIG.2) move on the main chassis 100 (see FIG. 2) in an unloading direction, the holder plate 212 ascends in relation to the sliding movements of the first and the second sliders 210 and 222 and the plate spring 230 ascends together with the holder plate 212. As the support pieces 234 of the plate spring 230 ascend, they raise the upper flange part 254 of the clamper 252, thereby distancing the clamper 252 from the disk D and the turntable 290. At this time, the clamper 252 must overcome the magnetic attraction exerted between the magnetic substance 270 and the magnet 292 to ascend. Differently from the conventional apparatus, since the plate spring 230 presses the clamper 252, the magnet 292 is not required to have a high magnetic force. Accordingly, the magnetic force that must be overcome to distance the clamper 252 from the disk D and the turntable 290 can be reduced, and thus a load generated in releasing the disk D from the chucking state can be reduced.

In contrast to the conventional disk chucking apparatus, in the disk chucking apparatus 200, since the magnet 290 is disposed on the turntable 290, the height of the clamper 252 can be reduced. Accordingly, a compact-sized disk player or a slim type disk player can be realized.

As described above, due to the presence of the plate spring 230, a clamping force sufficient to prevent the wobble is generated, and a magnet having a reduced magnetic force can be employed. And thus, a load generated in releasing the disk from the chucking state can be reduced.

Also, since the magnet 292 is disposed on the turntable 290, the height of the clamper 252 can be reduced, and thus, the compactness and slimming of the disk player can be achieved.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A disk chucking apparatus for a disk player, comprising:
a turntable on which a disk is seated;
a clamper unit to clamp the disk to the turntable; and
a holder unit, disposed on a main chassis to be approachable to and separable from the turntable, and pressing the clamper unit when the disk is clamped to the turntable, the clamper unit being rotatable.

2. The disk chucking apparatus as claimed in claim 1, wherein the holder unit comprises:
a holder plate disposed on the main chassis; and
a pressing member disposed on the holder plate to press a contact part upwardly protruding from a center of the clamper unit when the disk is clamped to the turntable.

3. The disk chucking apparatus as claimed in claim 2, wherein the pressing member is a plate spring.

4. The disk chucking apparatus as claimed in claim 3, wherein the contact part is dome-shaped.

5. The disk chucking apparatus as claimed in claim 3, wherein the contact part point-contacts the plate spring.

6. The disk chucking apparatus as claimed in claim 3, wherein a plurality of connection pieces are positioned at opposite ends of the plate spring, and the holder plate is provided with support projections supporting the connection pieces.

7. The disk chucking apparatus as claimed in claim 6, wherein the plate spring is provided with a support piece rotatably supporting the clamper unit.

8. The disk chucking apparatus as claimed in claim 1, wherein:
a magnet is disposed on the turntable; and
the clamper unit comprises
a clamper to clamp the disk seated on the turntable, and
a magnetic substance disposed on the clamper to generate an attraction with respect to the magnet, so that the clamper clamps the disk to the turntable with the attraction.

9. A disk chucking apparatus for a disk player, comprising:
a turntable on which a disk is seated, and the turntable having a magnet disposed thereon;
a holder plate disposed on a main chassis to be approachable to and separable from the turntable;
a clamper disposed at the holder plate, to clamp the disk seated on the turntable; and
a magnetic substance disposed on the clamper to generate an attraction with respect to the magnet so that the clamper clamps the disk to the turntable by the attraction, the clamper rotatably contacting the holder plate when the disk is clamped.

10. A disk chucking apparatus for a disk player, comprising:
a turntable rotatably connected to a spindle motor to rotate a disk seated thereon, the turntable having a magnet;
a holder unit disposed on a main chassis to move toward and away from the turntable; and
a clamper
rotatably disposed on the holder unit to clamp the disk to the turntable,
having a magnetic substance disposed therein, and
rotatably contacting the holder unit when the disk is clamped.

11. The disk chucking apparatus according to claim 10, wherein one of the clamper or the magnetic substance has a connection protrusion and the remaining one of the clamper or the magnetic substance has a corresponding connection recess that engages the connection protrusion via relative rotation between the clamper unit and the magnetic substance.

12. The disk chucking apparatus according to claim 10, wherein the clamper comprises a contacting part rotatably contacting the holder unit when the disk is clamped.

13. The disk chucking apparatus according to claim 12, wherein the contact part is dome-shaped.

14. The disk chucking apparatus according to claim 12, wherein the contact part point-contacts the holder unit.

15. The disk chucking apparatus according to claim 10, wherein the holder unit comprises a plurality of support pieces extending toward the turntable to rotatably support the clamper when the disk is not clamped.

16. The disk chucking apparatus according to claim 15, wherein the holder unit comprises:
a holder plate disposed on the main chassis to move toward and away from the turntable; and
a pressing member disposed on the holder plate and having the plurality of support pieces to rotatably support the clamper when the disk is not clamped, the pressing member pressing the clamper toward the turntable when the disk is clamped.

17. The disk chucking apparatus according to claim 16, wherein the pressing member is a plate spring.

18. The disk chucking apparatus according to claim 16, wherein the pressing member uses a coil spring to press the clamper.

19. A disk chucking apparatus for a disk player, comprising:
a turntable rotatably connected to a spindle motor to rotate a disk seated thereon, the turntable having a magnet;
a clamper having a magnetic substance disposed therein to correspond to the magnet; and
a holder unit, biasing the clamper toward the turntable when the disk is clamped between the clamper and the turntable, the clamper being rotatably disposed on the holder unit.

20. The disk chucking apparatus according to claim 19, wherein the holder unit and the turntable are mounted in the disk player such that they are moved relatively closer during a disk clamping operation and moved relatively apart during an unclamping operation.
